(19) United States
(12) Patent Application Publication
(10) Pub. No.: US 2014/0096852 A1
(43) Pub. Date: Apr. 10, 2014

(54) HYDRAULIC PRESSURE SUPPLY SYSTEM OF AUTOMATIC TRANSMISSION

(71) Applicant: HYUNDAI MOTOR COMPANY, Seoul (KR)

(72) Inventors: Taehwan WI, Bucheon-si (KR); Jin Young HWANG, Busan (KR); Se Hwan JO, Bucheon-si (KR)

(73) Assignee: Hyundai Motor Company, Seoul (KR)

(21) Appl. No.: 13/728,098

(22) Filed: Dec. 27, 2012

(30) Foreign Application Priority Data
Oct. 8, 2012 (KR) 10-2012-0111405

(51) Int. Cl. F16H 57/04

(52) U.S. Cl. CPC F16H 57/04
USPC 137/565.3

(57) ABSTRACT

A hydraulic pressure supply system of an automatic transmission generates low and high hydraulic pressures using oil stored in an oil pan and supplies the low and high hydraulic pressures respectively to a low and a high pressure portions. The system may include: a low-pressure hydraulic pump pumping the oil stored in the oil pan; a low-pressure regulator valve controlling the low hydraulic pressure to be stable hydraulic pressure, and supplying the stable hydraulic pressure to the low pressure portion; a high-pressure hydraulic pump changing the low hydraulic pressure into the high hydraulic pressure and supplying it to the high pressure portion; and a high-pressure regulator valve controlling the high hydraulic pressure to be stable hydraulic pressure, wherein the low-pressure and high-pressure hydraulic pumps are driven by one drive shaft, and the high-pressure hydraulic pump is a variable capacity hydraulic pump capable of controlling discharging flow amount.

### CROSS-REFERENCE TO RELATED APPLICATION

The present application claims priority of Korean Patent Application Number 10-2012-0111405 filed Oct. 8, 2012, the entire contents of which application is incorporated herein for all purposes by this reference.

### BACKGROUND OF INVENTION

1. Field of Invention

The present invention relates to a hydraulic pressure supply system of an automatic transmission for a vehicle. More particularly, the present invention relates to a hydraulic pressure supply system of an automatic transmission for a vehicle which prevents power loss by variably controlling discharging flow amount of a high-pressure hydraulic pump in the hydraulic pressure supply system having a low-pressure hydraulic pump and the high-pressure hydraulic pump driven by one drive shaft.

2. Description of Related Art

Recently, vehicle makers direct all their strength to improve fuel economy due to worldwide high oil prices and strengthen of exhaust gas regulations.

Improvement of fuel economy may be achieved by improving power delivery efficiency in an automatic transmission, and improvement of the power delivery efficiency may be achieved by minimizing unnecessary power consumption of a hydraulic pump.

A recent automatic transmission is provided with a low-pressure hydraulic pump and a high-pressure hydraulic pump so as to improve fuel economy. Therefore, hydraulic pressure generated by the low-pressure hydraulic pump is supplied to a low pressure portion (i.e., a torque converter, a cooling device, and a lubrication device), and hydraulic pressure generated by the high-pressure hydraulic pump is supplied to a high pressure portion (i.e., friction members selectively operated when shifting).

In further detail, general hydraulic pressure of the automatic transmission is generated for the low pressure portion (i.e., generated by the low-pressure hydraulic pump), and hydraulic pressure demanded by the high pressure portion is generated by the high-pressure hydraulic pump and then is supplied to the high pressure portion.

Since power consumption for driving the hydraulic pumps can be minimized, fuel economy may be enhanced. In addition, since a load applied to the hydraulic pumps is reduced, noise and vibration may be reduced and durability may be improved.

According to such an oil supply system, the low-pressure hydraulic pump and the high-pressure hydraulic pump are driven by one drive shaft. In this case, since rotation speeds of the low-pressure hydraulic pump and the high-pressure hydraulic pump cannot be independently controlled, oil amount larger than necessary oil amount may be supplied from the high-pressure hydraulic pump.

If the oil amount larger than necessary oil amount is supplied from the high-pressure hydraulic pump, the high hydraulic pressure higher than necessary hydraulic pressure may be generated. In addition, driving torque for driving the high-pressure hydraulic pump may be unnecessarily consumed so as to generate the high hydraulic pressure higher than the necessary hydraulic pressure.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a hydraulic pressure supply system of an automatic transmission for a vehicle having advantages of minimizing loss of power for driving a high-pressure hydraulic pump by variably controlling oil amount so as for a high-pressure hydraulic pump to generate necessary hydraulic pressure in the hydraulic pressure supply system having a low-pressure hydraulic pump and the high-pressure hydraulic pump driven by one drive shaft.

A hydraulic pressure supply system of an automatic transmission for a vehicle according to various aspects of the present invention is adapted to generate low hydraulic pressure and high hydraulic pressure using oil stored in an oil pan and supply the low hydraulic pressure and the high hydraulic pressure respectively to a low pressure portion and a high pressure portion.

The hydraulic pressure supply system may include: a low-pressure hydraulic pump pumping the oil stored in the oil pan and generating the low hydraulic pressure; a low-pressure regulator valve controlling the low hydraulic pressure supplied from the low-pressure hydraulic pump to be stable hydraulic pressure, and supplying the stable hydraulic pressure to the low pressure portion; a high-pressure hydraulic pump changing the low hydraulic pressure supplied from the low-pressure hydraulic pump into the high hydraulic pressure and supplying the high hydraulic pressure to the high pressure portion; and a high-pressure regulator valve controlling the high hydraulic pressure supplied from the high-pressure hydraulic pump to the high pressure portion to be stable hydraulic pressure, wherein the low-pressure hydraulic pump and the high-pressure hydraulic pump are driven by one drive shaft, and the high-pressure hydraulic pump is a variable capacity hydraulic pump capable of controlling discharging flow amount according to driving condition.

The high-pressure hydraulic pump may be a variable capacity vane pump.

The high-pressure hydraulic pump may be controlled by control pressure of a solenoid valve controlling the high-pressure regulator valve.

The solenoid valve may be a proportional control solenoid valve.

The variable capacity vane pump may include: a housing including an input port receiving the oil, an output port discharging the oil supplied to the input port, and a rotor chamber fluidly communicated with the input port and the output port; pumping means including an annular outer rotor disposed in the rotor chamber of the housing and having a load input end at a side of an exterior circumference thereof, an inner rotor disposed in and eccentric to the outer rotor and connected to the drive shaft, and a plurality of vanes inserted in an exterior circumference of the inner rotor so as to be slidable radially; and variable capacity control means disposed at a side portion of the housing and changing pump volume by controlling eccentric amount of the outer rotor according to the control pressure of the solenoid valve controlling the high-pressure regulator valve.

The variable capacity control means may include: a valve body having an inflow port formed at a side portion thereof and receiving the control pressure of the solenoid valve and an exhaust port formed at the other side portion thereof; a valve spool slidably mounted in the valve body and having a land and an operating rod protruded at the side surface of the land by a predetermined length and contacting with the load input end of the outer rotor; and an elastic member disposed between the other side surface of the land and the valve body.

The valve body may be integrally formed with the housing.

The valve body may be formed separately from the housing and may be mounted in the housing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary hydraulic pressure supply system according to the present invention.

FIG. 2 is a schematic diagram of an exemplary hydraulic pump used in a hydraulic pressure supply system according to the present invention.

FIG. 3 is a schematic diagram of an exemplary high-pressure hydraulic pump used in a hydraulic pressure supply system according to the present invention.

FIG. 4 is a cross-sectional view of variable capacity control means of an exemplary high-pressure hydraulic pump used in a hydraulic pressure supply system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the present exemplary embodiment will be omitted, and the same constituent elements are denoted by the same reference numerals in this specification.

In the detailed description, ordinal numbers are used for distinguishing constituent elements having the same terms, and have no specific meanings.

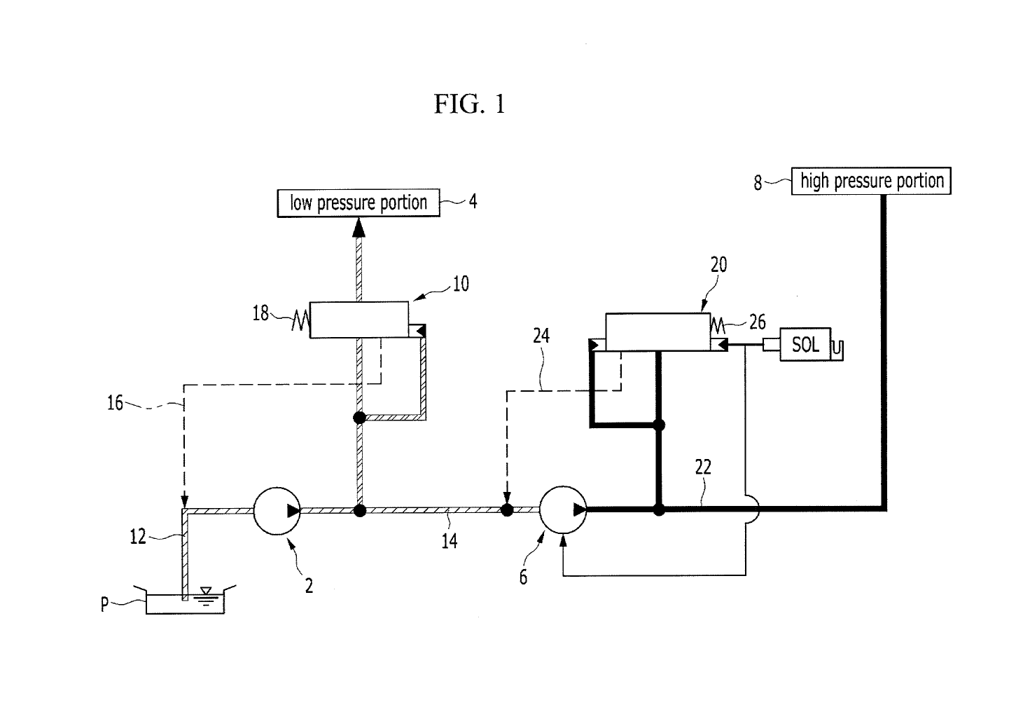

FIG. 1 is a schematic diagram of a hydraulic pressure supply system according to various embodiments of the present invention.

Referring to FIG. 1, a hydraulic pressure supply system according to various embodiments of the present invention is adapted to supply low hydraulic pressure generated by a low-pressure hydraulic pump 2 to a low pressure portion 4 such as a torque converter (T/C), a cooling portion, a lubrication portion and to supply high hydraulic pressure generated by a high-pressure hydraulic pump 6 to a high pressure portion 8 for operating friction members related to shifting.

The low hydraulic pressure is a lower pressure facilitating operation of the torque converter (T/C) and cooling and lubrication, and the high hydraulic pressure is a high pressure facilitating operation of a plurality of friction members.

The hydraulic pressure generated by the low-pressure hydraulic pump 2 is controlled to a stable hydraulic pressure by a low-pressure regulator valve 10 and is then supplied to the low pressure portion 4.

The low-pressure hydraulic pump 2 receives oil stored in an oil pan P through a first input line 12 and discharges the low hydraulic pressure to a first low-pressure line 14.

In addition, the low-pressure regulator valve 10 is connected to the first low-pressure line 14 and is connected to the first input line 12 through a first recirculation line 16.

Therefore, the low-pressure regulator valve 10 recirculates a portion of the hydraulic pressure supplied through the first low-pressure line 14 to the first input line 12 through the first recirculation line 16 so as to control the hydraulic pressure.

For this purpose, the low-pressure regulator valve 12 may be a spool valve and is controlled by elastic force of an elastic member 18 disposed at a side portion thereof and the hydraulic pressure of the first low-pressure line 14 supplied to the opposite side of the elastic member 18 so as to control opening area of the first recirculation line 16. Therefore, the hydraulic pressure supplied to the low pressure portion 4 can be controlled.

The hydraulic pressure generated by the high-pressure hydraulic pump 6 is controlled to be stable hydraulic pressure by a high-pressure regulator valve 20 and is then supplied to the high pressure portion 8.

The high-pressure hydraulic pump 6 changes the low hydraulic pressure supplied from the low-pressure hydraulic pump 2 into the high hydraulic pressure, and supplies the high hydraulic pressure to the high pressure portion 8 through a high-pressure line 22.

The high-pressure regulator valve 20 is connected to the high-pressure line 22 and is connected to the first low-pressure line 14 through a second recirculation line 24. Therefore, the high-pressure regulator valve 20 recirculates a portion of the hydraulic pressure supplied through the high-pressure line 22 to the first low-pressure line 14 through the second recirculation line 24 so as to control the hydraulic pressure.

For this purpose, the high-pressure regulator valve 20 may be a typical spool valve. In addition, the high-pressure regulator valve 20 is adapted to be controlled by control pressure of a solenoid valve SOL capable of performing proportional control, elastic force of an elastic member 26, and the hydraulic pressure of the high-pressure line 22 counteracting the control pressure of the solenoid valve SOL. The elastic force of the elastic member 26 is set according to the hydraulic pressure demanded by the high-pressure line 22.

As described above, the low hydraulic pressure generated by the low-pressure hydraulic pump 2 is supplied to the low pressure portion 4, and the high hydraulic pressure generated by the high-pressure hydraulic pump 6 is supplied to the high pressure portion 8.

The low-pressure hydraulic pump 2 and the high-pressure hydraulic pump 6 may be driven by separate power sources, but it is exemplified in various embodiments of the present invention that the low-pressure hydraulic pump 2 and the high-pressure hydraulic pump 6 are driven by one drive shaft.

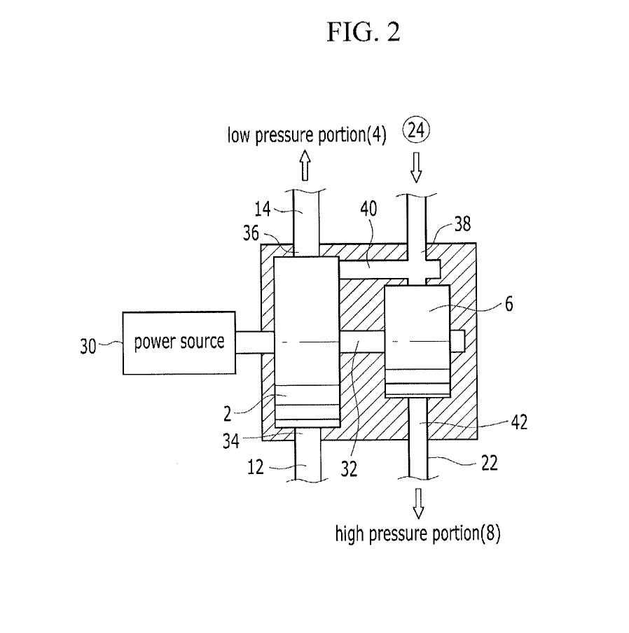

FIG. 2 is a schematic diagram of a hydraulic pump used in a hydraulic pressure supply system according to various embodiments of the present invention.

Referring to FIG. 2, the low-pressure hydraulic pump 2 and the high-pressure hydraulic pump 6 are driven by one power source 30 and the one drive shaft 32. The power source 30 may be an engine or a motor. If the power source 30 rotates the drive shaft 32, the low-pressure hydraulic pump 2 and the high-pressure hydraulic pump 6 disposed on the drive shaft 32 rotate to the same direction and generate the hydraulic pressure.

The low-pressure hydraulic pump 2 is connected to the first input line 12 through a first input hole 34 so as to receive the oil from the oil pan P, and is connected to the first low-pressure line 14 through a first output hole 36 so as to supply the low hydraulic pressure to the low pressure portion 4.

The high-pressure hydraulic pump 6 includes a second input hole 38, and the second input hole 38 is connected to the first output hole 36 through a connecting line 40 such that the high-pressure hydraulic pump 6 receives the hydraulic pressure generated by the low-pressure hydraulic pump 2. In addition, the high-pressure hydraulic pump 6 is connected to the high-pressure line 22 through a second output hole 42 so as to supply the high hydraulic pressure to the high pressure portion 8.

The connecting line 40 is included in the first low-pressure line 14 shown in FIG. 1 and the second input hole 38 is connected to the second recirculation line 24.

In addition, the high-pressure hydraulic pump 6 is a variable capacity vane pump according to various embodiments of the present invention.

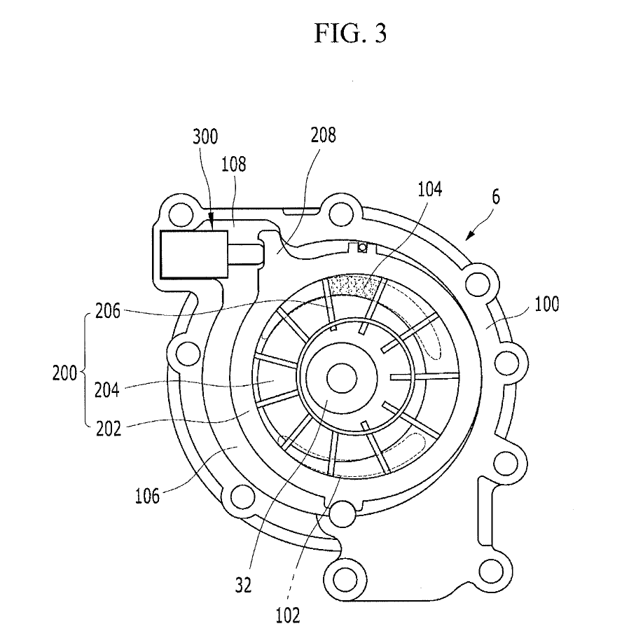

FIG. 3 is a schematic diagram of a high-pressure hydraulic pump used in a hydraulic pressure supply system according to various embodiments of the present invention.

Referring to FIG. 3, the high-pressure hydraulic pump 6 is the variable capacity vane pump and the variable capacity vane pump includes a housing 100, pumping means 200, and variable capacity control means 300.

The housing 100 includes an input port 102 receiving the oil and an output port 104 discharging the oil supplied to the input port 102. In addition, the housing 100 further includes a rotor chamber 106 connected to the input port 102 so as to receive the oil and connected to the output port 104 so as to discharge the oil.

The pumping means 200 include an outer rotor 202, an inner rotor 204, and a plurality of vanes 206.

The outer rotor 202 has an annular shape and is disposed in the rotor chamber 106 of the housing 100. A load input end 208 is formed at a side of an exterior circumference of the outer rotor 202.

The inner rotor 204 is disposed in and is eccentric to the outer rotor 202 and is connected to the drive shaft 32.

The plurality of vanes 206 is inserted in an exterior circumference of the inner rotor 204 so as to be slidable radially, and is disposed circumferentially with even distances.

Therefore, if the inner rotor 204 rotates, the vane 206 is pushed radially outwardly and a free end of the vane contacts with an interior circumference of the outer rotor 202.

The pumping means 200 pressurizes the oil supplied to the rotor chamber 106 when the inner rotor 204 is rotated by the drive shaft 32, and feeds the pressurized oil to the output port 104.

The variable capacity control means 300 is disposed in a receiving chamber 108 formed at a side portion of the housing 100, and controls eccentric amount of the outer rotor 202 according to driving condition so as to control pump volume.

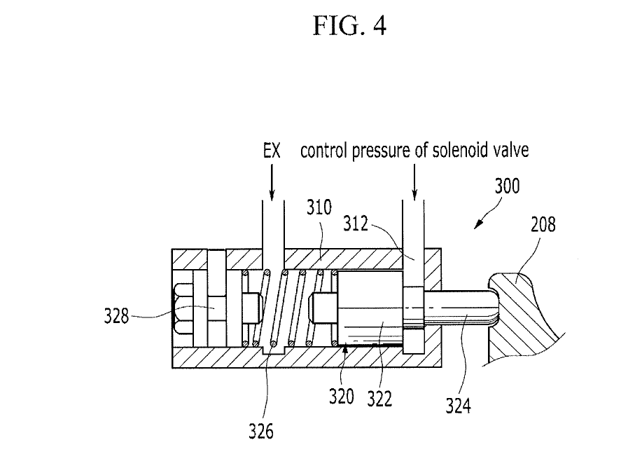

FIG. 4 is a cross-sectional view of variable capacity control means of a high-pressure hydraulic pump used in a hydraulic pressure supply system according to various embodiments of the present invention.

The variable capacity control means 300 includes a valve body 310 and a valve spool 320.

The valve body 310 may be monolithically formed with the housing 100 or may be formed separately from the housing and is mounted in the receiving chamber 108.

The valve body 310 includes an inflow port 312 formed at a side portion thereof and receiving the control pressure of the solenoid valve SOL and an exhaust port EX formed at the other side portion thereof.

The valve spool 320 slidably mounted in the valve body 310 includes one land 322 and an operating rod 324 protruded from a side surface of the land 322 by a predetermined length and contacting with the load input end 208 of the outer rotor 202.

An elastic member 326 is disposed at the other side surface of the land 322 and the valve body 310.

Therefore, the control pressure supplied into the inflow port 312 is applied to the side surface of the land 322 of the valve spool 320 and elastic force of the elastic member 326 is applied to the other side surface of the land 322. Therefore, the valve spool 320 moves to the left or to the right in the drawing by the control pressure and the elastic force.

The elastic member 326 is disposed between the land 322 of the valve spool 320 and an adjust bolt 328, and pushes the valve spool 320 to the right in the drawing so as for the operating rod 324 to contact with the load input end 208 at an initial operating state.

In addition, the elastic force of the elastic member 326 may be set according to the control pressure supplied into the inflow port 312 by a person of an ordinary skill in the art.

Discharging flow amount of the high-pressure hydraulic pump 6 is determined according to the control pressure of the solenoid valve SOL supplied into the inflow port 312 of the variable capacity control means 300.

That is, if the control pressure of the solenoid valve SOL is not supplied, the valve spool 320 is pushed to the right in the drawings by the elastic force of the elastic member 326 and eccentric amount of the outer rotor 202 increases, as shown in FIG. 3 and FIG. 4. Therefore, the discharging flow amount of the high-pressure hydraulic pump 6 is increased.

On the contrary, if the control pressure of the solenoid valve SOL is supplied, the control pressure of the solenoid valve SOL wins against the elastic force and the valve spool 320 is moved to the left in the drawings. Therefore, the eccentric amount of the outer rotor 202 is reduced and the discharging flow amount of the high-pressure hydraulic pump 6 is also reduced.

Since the high-pressure hydraulic pump 6 is the variable capacity vane pump and the discharging flow amount of the variable capacity vane pump is variably controlled by the control pressure of the solenoid valve SOL controlling the hydraulic pressure of high pressure portion 8, generation of the hydraulic pressure that is unnecessarily high is prevented according to various embodiments of the present invention.

In addition, since generation of unnecessary hydraulic pressure is prevented, driving torque for driving the high-pressure hydraulic pump 6 may be minimized and power loss may be reduced.

For convenience in explanation and accurate definition in the appended claims, the terms lower and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A hydraulic pressure supply system of an automatic transmission for a vehicle which generates low hydraulic pressure and high hydraulic pressure using oil stored in an oil pan and supplies the low hydraulic pressure and the high hydraulic pressure respectively to a low pressure portion and a high pressure portion, the hydraulic pressure supply system comprising:
a low-pressure hydraulic pump pumping the oil stored in the oil pan and generating the low hydraulic pressure;
a low-pressure regulator valve controlling the low hydraulic pressure supplied from the low-pressure hydraulic pump to be stable hydraulic pressure, and supplying the stable hydraulic pressure to the low pressure portion;
a high-pressure hydraulic pump changing the low hydraulic pressure supplied from the low-pressure hydraulic pump into the high hydraulic pressure and supplying the high hydraulic pressure to the high pressure portion; and
a high-pressure regulator valve controlling the high hydraulic pressure supplied from the high-pressure hydraulic pump to the high pressure portion to be stable hydraulic pressure,
wherein the low-pressure hydraulic pump and the high-pressure hydraulic pump are driven by one drive shaft, and the high-pressure hydraulic pump is a variable capacity hydraulic pump capable of controlling discharging flow amount according to a driving condition.

2. The hydraulic pressure supply system of claim 1, wherein the high-pressure hydraulic pump is a variable capacity vane pump.

3. The hydraulic pressure supply system of claim 1, wherein the high-pressure hydraulic pump is controlled by control pressure of a solenoid valve controlling the high-pressure regulator valve.

4. The hydraulic pressure supply system of claim 3, wherein the solenoid valve is a proportional control solenoid valve.

5. The hydraulic pressure supply system of claim 2, wherein the variable capacity vane pump comprises:
a housing including an input port receiving the oil, an output port discharging the oil supplied to the input port, and a rotor chamber fluidly communicated with the input port and the output port;
pumping means including an annular outer rotor disposed in the rotor chamber of the housing and having a load input end at a side of an exterior circumference thereof, an inner rotor disposed in and eccentric to the outer rotor and connected to the drive shaft, and a plurality of vanes inserted in an exterior circumference of the inner rotor so as to be slidable radially; and
variable capacity control means disposed at a side portion of the housing and changing pump volume by controlling eccentric amount of the outer rotor according to the control pressure of the solenoid valve controlling the high-pressure regulator valve.

6. The hydraulic pressure supply system of claim 5, wherein the variable capacity control means comprise:
a valve body having an inflow port formed at a side portion thereof and receiving the control pressure of the solenoid valve and an exhaust port formed at the other side portion thereof;
a valve spool slidably mounted in the valve body and having a land and an operating rod protruded at the side surface of the land by a predetermined length and contacting with the load input end of the outer rotor; and
an elastic member disposed between the other side surface of the land and the valve body.

7. The hydraulic pressure supply system of claim 6, wherein the valve body is integrally formed with the housing.

8. The hydraulic pressure supply system of claim 6, wherein the valve body is formed separately from the housing and is mounted in the housing.
